(19) United States
(12) Patent Application Publication
(10) Pub. No.: US 2005/0069328 A1
(43) Pub. Date: Mar. 31, 2005

(54) Infrared detection sensor

(76) Inventor: Masashi Iwasawa, Otsu (JP)

Correspondence Address: WENDEROTH, LIND & PONACK, L.L.P., 2033 K STREET N. W., SUITE 800, WASHINGTON, DC, 20006-1021, US

(21) Appl. No.: 10/947,246

(22) Filed: Sep. 23, 2004

(30) Foreign Application Priority Data
Sep. 25, 2003 (JP) 2003-333722

(51) Int. Cl. H04B 10/00

(52) U.S. Cl. 398/151; 398/140

(57) ABSTRACT

An infrared detection sensor is provided with a phototransmitter including light projection portions projecting infrared rays, and a photoreceiver including light reception portions, which are respectively placed opposite to the light projection portions, receiving the infrared rays from the light projection portions. The light projection portions are made of upper and lower light projection portions, and the light reception portions are made of upper and lower light reception portions. The phototransmitter includes a light projection control means for increasing a signal output level of a leading edge portion in the infrared rays projected from the light projection portions.

### CROSS-REFERENCE TO RELATED APPLICATION

The present application claims the priority under 35 U.S.C. §119(a) on Patent Application Number 2003-333722, filed in Japan on Sep. 25, 2003, the subject matter of which is hereby incorporated herein by reference.

### BACKGROUND OF THE INVENTION

1. Field of the Invention

The present invention relates to infrared detection sensors. In particular, the present invention relates to infrared detection sensors which detect an intrusion of an object into a detection zone when an object intruding into the detection zone disrupts infrared rays projected from light projection portions to light reception portions.

2. Description of the Related Art

Among sensors using infrared rays, there are infrared detection sensors, which are provided with light projection portions and light reception portions, and which detect a status of disruption of infrared rays projected from the light projection portions.

Among such conventional infrared detection sensors, there are infrared detection sensors that are provided with, for example, a phototransmitter and a photoreceiver including upper and lower light projection and upper and lower reception portions that simultaneously project infrared rays whose signal data are identical, from the upper and lower light projection portions to the opposite light reception portions respectively, and which detect an intrusion of an object only when both of the infrared rays are disrupted by the object.

Such conventional infrared detection sensors project the infrared rays simultaneously from the upper and lower light projection portions to the opposite light reception portions respectively, so that each of the upper and lower light reception portions receives mixed infrared signal data. Therefore, the signal level of the infrared rays received at the light reception portions is increased, making it possible to eliminate detection errors. This also makes it possible to address the degradation of the signal level caused by the distance between the light projection portions and the light reception portions, so that the light projection distance can be prolonged. Still, since the light reception portions receive mixed signal data from the upper and lower light projection portions, detection errors happen unless the signal data in the upper and lower infrared rays are identical.

However, if the signal data of the infrared rays projected from the upper and lower light projection portions are signal data representing identical information, they cannot detect objects that disrupt only one of the infrared rays, for example, they cannot detect small animals which disrupt the infrared rays projected from the lower light projection portion only.

Therefore, as other infrared detection sensors, there are now infrared detection sensors, which are provided with upper and lower light projection and upper and lower reception portions that are enabled to detect not only persons but also small animals (see JP H9-297184A for example).

The infrared detection sensor according to JP H9-297184A (referred to as “infrared detection device” in JP H9-297184A) is provided with a phototransmitter including upper and lower light projection portions each projecting independent infrared rays, and a photoreceiver including upper and lower light reception portions which are placed opposite the corresponding light projection portions.

This infrared detection sensor projects the different infrared rays from the upper and lower light projection portions to the corresponding opposite upper and lower light reception portions respectively at different timings, thus forming independent detection zones.

With this infrared detection sensor, the signal pulses of the infrared rays projected from the upper and lower light projection portions are different signal pulses, and the upper and lower independent detection zones are formed by the upper and lower light projection and upper and lower reception portions. Therefore, it is possible to detect an intrusion of an object into these detection zones, independently at each detection zone. Consequently, it is possible to detect, for example, an intrusion of even small animals that disrupt the infrared rays from the lower light projection portion only, when the small animals disrupt the infrared rays from the lower light projection portion.

However, in the infrared detection sensor according to JP H9-297184A, the signals of the infrared rays projected from the upper and lower light projection portions are constituted by different signal pulses. The signals, which are projected from the light projection portions to the light reception portions so that they do not overlap each other, are passed to a synchronous wave detector controlled by a synchronization signal generation portion in the light reception portions, making each of the detection zones, formed by the light projection from the upper and lower light projection portions, independent. Therefore, unlike the infrared detection sensors projecting the infrared rays from the upper and lower light projection portions simultaneously, the infrared rays from the upper and lower light projection portions are not projected simultaneously to the upper and lower light reception portions, so that the output level of the leading edge portion of signals which have been input and amplified by the light reception portions is low, and the signal output level of the infrared rays has only the same signal output level as infrared detection sensors which have substantially one light projection and one light reception portion. As a result, with the sensitivity to infrared rays of the infrared detection sensor according to JP H9-297184A, the input level of the received infrared rays is lower in the infrared detection sensors which project the infrared rays from upper and lower light projection portions simultaneously, so that the detection operation for detecting an object intruding into the detection zone becomes unstable, and the light projection distance cannot be prolonged because detection errors are likely to happen.

Thus, in order to solve the problem, it is an object of the present invention to provide an infrared detection sensor that stabilizes an operation of detecting objects intruding into a plurality of independent detection zones formed by a plurality of different infrared rays, without decreasing a signal input level of the leading edge.

### SUMMARY OF THE INVENTION

In order to achieve the above objects, an infrared detection sensor according to the present invention is provided with a phototransmitter including a plurality of light projection portions projecting independent infrared rays, and a photoreceiver including a plurality of light reception portions which are respectively placed opposite to the plurality of light projection portions, wherein different infrared rays are projected from the plurality of light projection portions to the plurality of opposite light reception respectively, at different timings and with predetermined intervals, forming a plurality of independent detection zones; an intrusion of an object into the detection zones is detected when an object intruding into the detection zones disrupts the projection of the infrared rays from the phototransmitter to the photoreceiver; and the phototransmitter is provided with a light projection control means for increasing a signal output level of a leading edge portion of the infrared rays.

Since the invention is provided with a light projection control means, the signal input level, when the infrared rays are input at the light reception portion, can be set to an input level that is high enough for reception, from the leading edge to the trailing edge. Thus, the reception sensitivity to the infrared rays at the photoreceiver can be improved. As a result, it is possible to stabilize a detection operation for detecting objects such as persons or small animals intruding into the plurality of independent detection zones, formed by the plurality of different infrared rays, without decreasing the signal input level at the light reception portions.

The light projection control means increases not the signal output level of the entire infrared rays, two of which are sent simultaneously, but only the signal output level of the leading edge portion in the infrared rays. Therefore, it is also possible to reduce the power consumption of the infrared detection sensor.

In the above configuration, it is also possible that signal data in the infrared rays include preamble portions, that the light projection control means projects the infrared rays from the plurality of light projection portions to the plurality of light reception portions, at different timings and with predetermined intervals, and that the projection of the infrared rays is set by the light projection control means so that the infrared rays overlap each other only at the preamble portions or a part of the data of at least two of the infrared rays projected by the plurality of light projection portions.

In this case, since signal the data in the infrared rays include preamble portions, the light projection control means projects the infrared rays from the plurality of light projection portions to the plurality of light reception portions at different timings and with predetermined intervals, and the projection of the infrared rays is set by the light projection control means so that the infrared rays overlap each other only at the preamble portions or a part of the data of at least two of the infrared rays projected by the plurality of light projection portions, the manufacturing cost can be lowered, because the phototransmitter and the photoreceiver need not be provided with additional complicated structures.

More specifically, with the light projection control means, the preamble portions or a part of the data of at least two of the infrared rays projected from the plurality of light projection portions may overlap each other for at least one Bit. Or, the preamble portions or a part of the data of at least two of the infrared rays projected from the plurality of light projection portions may overlap each other for a predetermined time.

In the above configuration, the phototransmitter may be provided with an identification means for identifying the light reception portion which received the infrared rays, among the plurality of light reception portions.

In this case, the phototransmitter is provided with the identification means, which makes it easy to identify each of the infrared rays projected from the plurality of light projection portions, at the photoreceiver. An example of an identification means is a selection switch circuit or like, which makes it easy to identify the light reception portion that received the infrared rays, by disconnecting the receiving portion that should not receive the infrared rays. Alternatively, it is possible to recognize the detection zone at the light reception portion from the contents of the projected data.

In the above configuration, the detection zone formed by the infrared rays projected from the plurality of light projection portions may be made of a plurality of layers.

In this case, a plurality of detection zones can be formed vertically, so it is possible to distinguish objects such as small animals, birds, or weeds, from persons which are to be detected as intruders.

As mentioned above, the infrared detection sensor according to the present invention can stabilize the operation to detect an object intruding into the plurality of independent detection zones formed by the plurality of different infrared rays, without decreasing the signal input level of the leading edge.

That is, in the infrared detection sensor according to the present invention, the phototransmitter is provided with the light projection control means for increasing the signal output level of the leading edge portion in the infrared rays, so that the signal input level can be set to an input level that is high enough to be received by the light reception portions, from the leading edge to the trailing edge in the infrared ray at the light reception portion.

The light projection control means increases not the signal output level of the entire infrared rays, but only the signal output level of the leading edge portion in the infrared rays. Therefore, it is also possible to reduce the power consumption of the infrared detection sensor.

Also, since the present invention has the above-described configuration, it is preferable that it is applied to infrared sensors for crime prevention.

### BRIEF DESCRIPTION OF THE DRAWINGS

FIG. 1 shows a schematic block diagram of an infrared detection sensor according to an embodiment of the present invention.

FIG. 2 is a diagram illustrating infrared rays projected from light projection portions to light reception portions and the change in the signal output level of the infrared rays, during projection of light, in an infrared detection sensor according to an embodiment of the present invention.

### DESCRIPTION OF THE PREFERRED EMBODIMENTS

Hereinafter, an embodiment of the invention is described with reference to the appended drawings. The following description relates to the case of applying the invention to an infrared detection sensor for crime prevention. Infrared detection sensors according to the invention, however, are not limited to this, and can be used in various applications.

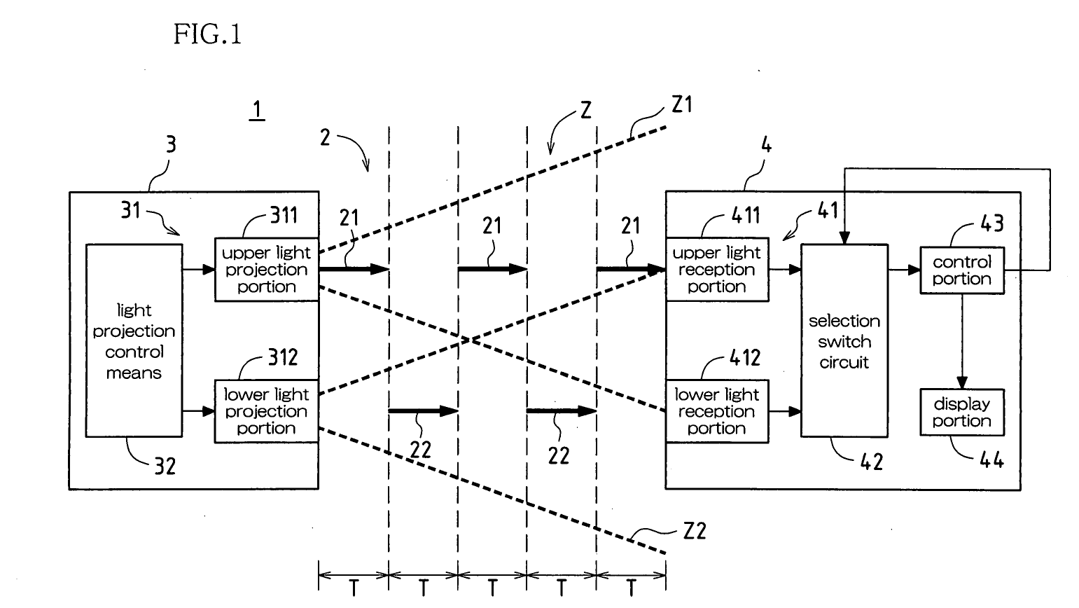

As shown in FIG. 1, an infrared detection sensor 1 according to this embodiment is provided with a phototransmitter 3 including a light projection portion 31 projecting infrared rays 2, and a photoreceiver 4 including a light reception portion 41 receiving the infrared rays 2 from the light projection portion 31. An intrusion of an object into a detection zone Z is detected when a projection of the infrared rays 2 from the phototransmitter 3 to the photoreceiver 4 is disrupted.

The light projection portion 31 is made of upper and lower light projection portions (an upper light projection portion 311 and a lower light projection portion 312). The light reception portion 41 is made of upper and lower light reception portions (an upper light reception portion 411 and a lower light reception portion 412). The upper and lower light reception portions 411 and 412 are placed opposite the upper and lower light projection portions 311 and 312. The upper and lower light projection and light reception portions 311, 312, 411, and 412 each have a plurality of light projection or reception elements (not shown in the drawings) and an optical mirror (not shown in the drawings), respectively.

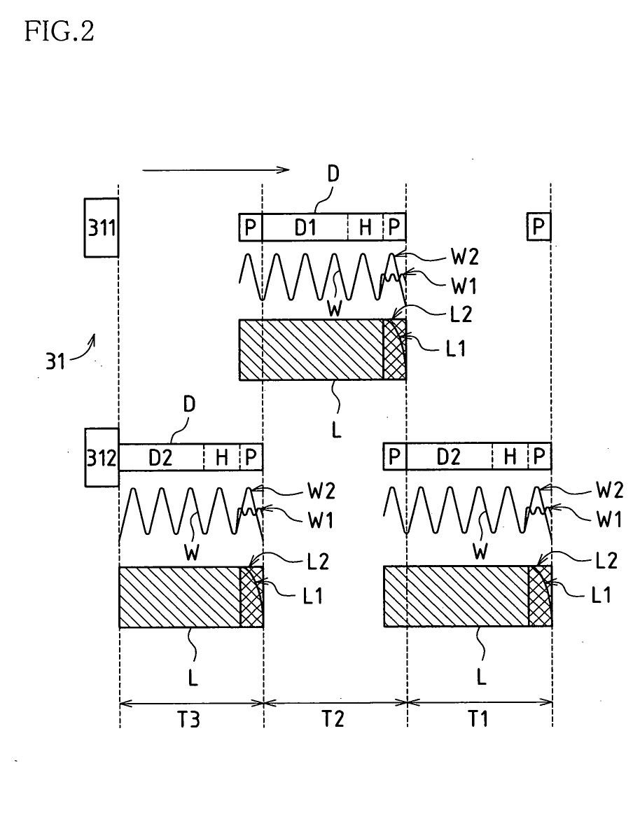

Different upper and lower infrared rays 21 and 22 are projected from the upper and lower light projection portions 311 and 312 are different from each other. As shown in FIG. 2, signal data in the infrared ray 2 have a packet format including a preamble portion P, a header portion H, and a data portion D. The different data portions D (an upper data portion D1 and a lower data portion D2), make the upper and lower infrared rays 21 and 22 different from each other. FIG. 2 shows a signal wave W of signal data in the projected infrared ray 2, and a signal input level L at the light reception portion 41.

The phototransmitter 3 is provided with a light projection control means 32 for increasing a signal output level of a leading edge portion in the infrared rays 2 projected from the light projection portion 31.

This light projection control means 32 is set to project the upper and lower infrared rays 21 and 22, from the upper and lower light projection portions 311 and 312 to the opposite upper and lower light reception portions 411 and 412 respectively, at different timings and with predetermined constant intervals (see the setting time T in FIG. 1). At the same time, the projection of the upper and lower infrared rays 21 and 22 is set so that the upper and lower infrared rays 21 and 22 overlap each other at the preamble portions P only. That is, as shown in FIG. 2, the upper and lower data portions D1 and D2 in the upper and lower infrared rays 21 and 22 projected from the upper and lower light projection portions 311 and 312 are set by the light projection control means 32, to be independent so that they do not overlap each other on the time axis. Therefore, the upper and lower infrared rays 21 and 22 are easily synchronized. The preamble portions P of the initial data projection are made of several bits.

The light projection control means 32 also projects an infrared ray 2 of signal data, which includes only the preamble portion P, from the light projection portion 31 to the light reception portion 41. For example, as shown in FIG. 2, when the lower light projection portion 312 projects the lower infrared ray 22, at the same time, the upper light projection portion 311 projects the upper infrared ray 21, but only for the time during which the preamble portion P in the lower infrared ray 22 is sent. Therefore, the signal input level of the lower infrared ray 22 increases from a signal input level L1 to a signal input level L2.

The photoreceiver 4 includes a selection switch circuit 42 (also related to as “identification means” in the invention) identifying which of the upper and lower light reception portions 411 and 412 received the infrared ray 2, a control portion 43 detecting an intrusion of an object into the detection zones Z1 or Z2 depending on whether or not the upper and lower infrared rays 21 or 22 are received at the upper or lower light reception portions 411 or 412, and a display portion 44 indicating the presence or absence of an intrusion of an object into the detection zone Z.

The selection switch circuit 42 switches between the upper and lower light reception portions 411 and 412 in order to identify signal data representing the information of the upper and lower infrared rays 21 and 22, which are independent on the time axis, received by the photoreceiver 4 from the phototransmitter 3.

Next, the projection of infrared rays from the light projection portion 31 to the light reception portion 41 in the infrared detection sensor 1 is described with reference to FIG. 1 and FIG. 2.

First, as shown in FIG. 2, an infrared ray 2 is projected from the lower light projection portion 312 to the lower light reception portion 412, the infrared ray 2 including data wherein a preamble portion P, a header portion H, a lower data portion D2, and a preamble portion P are arranged in this order. At the same time, an infrared ray 2 of signal data, which includes only a preamble portion P, is projected from the upper light projection portion 311 to the upper light reception portion 411. While projecting this light, the preamble portion P in the upper infrared ray 21 from the upper light projection portion 311 overlaps with the preamble portion P in the lower infrared ray 22 from the lower light projection portion 312. Then, as shown in FIG. 2, the leading edge portion of the signal wave W of the infrared ray 2 is combined and changed from reference symbol W1 to reference symbol W2, and the leading edge portion of the signal input level L is increased from reference symbol L1 to reference symbol L2.

During T2, after a predetermined time has passed (after the time T1 in FIG. 2), the upper infrared ray 21 is projected from the upper light projection portion 311 to the upper light reception portion 411, the upper infrared ray including data wherein a preamble portion P, a header portion H, an upper data portion D1, and a preamble portion P are arranged in this order. While projecting this light, in the lower infrared ray 22 from the lower light projection portion 312, the preamble portion P at the end of the signal data is projected to the lower light reception portion 412, and the preamble portion P in the upper infrared ray 21 from the upper light projection portion 311 overlaps with the preamble portion P in the lower infrared ray 22 from the lower light projection portion 312. Then, as shown in FIG. 2, the leading edge portion of the signal wave W of the infrared ray 2 is combined and changed from reference symbol W1 to reference symbol W2, and the leading edge portion of the signal input level L is increased from reference symbol L1 to reference symbol L2.

Furthermore, during T3, after a predetermined time has passed (after the time T2 in FIG. 2), the infrared ray 2 is projected from the lower light projection portion 312 to the lower light reception portion 412, and the infrared ray 2 including data wherein a preamble portion P, a header portion H, a lower data portion D2, and a preamble portion (not shown in the drawings) are arranged in this order. While projecting this light, in the upper infrared ray 21 from the upper light projection portion 311, the preamble portion P at the end of the signal data is projected to the upper light reception part 411, and the preamble portion P in the upper infrared ray 21 from the upper light projection portion 311 overlaps with the preamble portion in the lower infrared ray 22 from the lower light projection portion 312. Then, as shown in FIG. 2, the leading edge portion of the signal wave W of the infrared ray 2 is combined and changed from reference symbol W1 to reference symbol W2, and the leading edge portion of the signal input level L is increased from reference symbol L1 to reference symbol L2.

Then, the infrared ray 2 continues to be projected from the upper and lower light projection portions 311 and 312, to the upper and lower light reception portions 411 and 412, like the above-described infrared ray 2 projected from the light projection portion 31 to the light reception portion 41.

As shown in FIG. 1, in this infrared detection sensor 1, the detection zone Z is formed between the light projection portion 31 and the light reception portion 41, by the projection of the infrared rays 2 from the light projection portion 31 to the light reception portion 41. That is, as shown in FIG. 1, the infrared ray is projected from the light projection portion 31 to the light reception portion 41. The projection of the upper infrared ray 21 from the upper light projection portion 311 to the upper light reception portion 411 forms the upper detection zone Z1 between the upper light projection portion 311 and the upper light reception portion 411. The projection of the lower infrared ray 22 from the lower light projection portion 312 to the lower light reception portion 412 forms the lower detection zone Z2 between the lower light projection portion 312 and the lower light reception portion 412.

As described above, this infrared detection sensor 1 is provided with the light projection control means 32. Therefore, the signal input level L at the light reception portion 41 can be set to an input level that is high enough to be received by the light reception portion 41, from the leading edge to the trailing edge in the infrared ray 2. Thus, the reception sensitivity to the infrared ray 2 at the photoreceiver 4 can be improved. As a result, it is possible to stabilize the detection operation for detecting an intrusion of an object such as a person or a small animal into either of the two independent detection zones Z1 or Z2, formed by the infrared rays 21 or 22, without decreasing the signal input level L.

The light projection energy of the infrared ray 2 can be increased by the light projection control means 32, which results in an extended security distance or a prolonged light projection distance, compared with the infrared detection sensor described in JP H9-297184A.

The light projection control means 32 increases not the signal output level of the entire infrared ray 2, but the signal output level only of the preamble portion P, that is, the leading edge portion in the infrared ray 2. Therefore, it can also reduce power consumption of the infrared detection sensor 1.

The signal data in the infrared ray 2 include the preamble portion. The light projection control means 32 projects the infrared ray 2, from the upper and lower light projection portions 311 and 312 to the upper and lower light reception portions 411 and 412, at different timings and with predetermined constant intervals T (see FIG. 1). The light projection from the upper and lower light projection portions 311 and 312 is set so that the upper and lower infrared rays 21 and 22 from the upper and lower light projection portions 311 and 312 overlap each other at the preamble portions only. Therefore, the manufacturing cost of the infrared detection sensor 1 can be lowered, since the phototransmitter 3 and the photoreceiver 4 need not be provided with additional complicated structures.

The photoreceiver 4 is provided with a selection switch circuit 42 to identify easily which portion received the infrared ray 2, by disconnecting the receiving portion that does not receive the infrared ray 2 of the upper and lower infrared rays 21 and 22 from the upper and lower light projection portions 311 and 312.

The light projection portion 31 and the light reception portion 41 are arranged vertically above one another, and form two detection zones Z vertically (the upper and the lower detection zones Z1 and Z2), so it is possible to distinguish objects such as small animals, birds, or weeds, from persons which are to be detected as intruders.

In the infrared detection sensor 1 according to this embodiment, the light projection portion 31 and the light reception portion 41 are vertically independent, so that it is possible to perform a sensitivity adjustment or like with vertically independent mirrors of the light projection portion 31 and the light reception portion 41.

In this embodiment, the light projection portion 31 and the light reception portion 41 are both made of upper and lower elements. However, there is no limitation to this, and as long as the light projection portions and the light reception portions are arranged in pairs, there may be any plural number of light projection portions 31 and light reception portions 41.

In this embodiment, the light projection portion 31 and the light reception portion 41 are both made of upper and lower elements. However, there is no limitation to this, and it is also possible to arrange the upper and lower projection and reception portions 311, 312, 411, and 412 constituting the light projection portion 31 or the light reception portion 41 at other positions. For example, they also can be arranged horizontally instead of vertically. In this case, the two detection zones Z1 and Z2, formed by the light projection portion 31 and the light reception portion 41, are formed horizontally, and can detect objects such as a person who has moved across the two detection zones Z1 and Z2.

In this embodiment, a selection switch circuit 42 was used as an identification means according to the invention. However, there is no limitation to this, and as long as it is possible at the photoreceiver to identify easily the upper and lower infrared rays 21 and 22 from the upper and lower light projection portions 311 and 312, it is also possible to let the frequencies of the infrared rays from the upper and lower light projection portions 311 and 312 differ, to provide the light reception portion 41 with a filter which disrupts the infrared rays according to the value of the frequency, and to restrict the infrared rays to be received by the light reception portions 411 and 412 with the filter. In this case, the infrared rays should overlap each other with regard to the value of their frequency.

It is also possible to use a signal recognition portion for recognizing the signal of the infrared rays as an identification means, to let the signal contents of the infrared rays projected from the upper and lower light projection portions 311 and 312 differ, and to recognize the corresponding signal (i.e. upper or lower infrared ray) at the light reception portion with this signal recognition portion.

In this embodiment, the projection of the upper and lower infrared rays 21 and 22 is set by the light projection control means 32 so that they overlap each other at their preamble portions only. However, there is no limitation to this. For example, the first part of the signal data can be the header portion, and the projection of the upper and lower infrared rays 21 and 22 can be set to overlap each other at the header portion only.

In this embodiment, the infrared ray 2 is made of the upper and lower infrared rays 21 and 22. However, there is no limitation to this. For example, it is possible to increase the number of sub-portions of the light projection portion 31 and the light reception portion 41, and in accordance with this increase, to increase the number of the infrared rays. In this case, the projection of a plurality of the different infrared rays should be set to overlap at two or more preamble portions only, of the three or more infrared rays from the three or more light projection portions.

In this embodiment, the light projection portion 31 and the light reception portion 41 have a plurality of light projection or reception elements and a mirror (optical system), respectively. However, there is no limitation to this, and they may have one or more light projection or reception elements and another optical system. They also can have only one or more light projection or reception elements. It is possible to change the configuration of the light projection or reception portions, in accordance with the application.

In this embodiment, as shown in FIG. 2, the projection of the infrared rays is set by the light projection control means 32 so that the infrared rays 21 and 22 from the upper and lower light projection portions 311 and 312 overlap each other through the entire data of the preamble portions P. However, there is no limitation to this, and as long as the overlap is in a leading edge portion of the infrared ray 2, it is also possible that the preamble portions P or a part of the data of the upper and lower infrared rays 21 and 22 are overlapped for at least one Bit, or that the preamble portions P or a part of the data of the upper and lower infrared rays 21 and 22 overlap each other for a predetermined time.

As mentioned above, the invention can be applied to an infrared detection sensor for crime prevention.

The invention may be embodied in other forms without departing from the spirit or essential characteristics thereof. The embodiment disclosed in this application is to be considered in all respects as illustrative and not limiting. The scope of the invention is indicated by the appended claims rather than by the foregoing description, and all changes which come within the meaning and range of equivalency of the claims are intended to be embraced therein.

1. A infrared detection sensor, comprising:
a phototransmitter including a plurality of light projection portions projecting independent infrared rays; and
a photoreceiver including a plurality of light reception portions which are respectively placed opposite to the plurality of light projection portions;
wherein different infrared rays are projected from the plurality of light projection portions to the plurality of opposite light reception respectively, at different timings and with predetermined intervals, forming a plurality of independent detection zones;
wherein an intrusion of an object into the detection zones is detected when an object intruding into the detection zones disrupts the projection of the infrared rays from the phototransmitter to the photoreceiver; and
wherein the phototransmitter is provided with a light projection control means for increasing a signal output level of a leading edge portion of the infrared rays.

2. The infrared detection sensor according to claim 1,
wherein signal data in the infrared rays include preamble portions,
wherein the light projection control means projects the infrared rays from the plurality of light projection portions to the plurality of light reception portions, at different timings and with predetermined intervals, and
wherein the projection of the infrared rays is set by the light projection control means so that the infrared rays overlap each other only at the preamble portions or a part of the data of at least two of the infrared rays projected by the plurality of light projection portions.

3. The infrared detection sensor according to claim 2,
wherein the preamble portions or a part of the data of at least two of the infrared rays projected from the plurality of light projection portions overlap each other for at least one Bit.

4. The infrared detection sensor according to claim 2,
wherein the preamble portions or a part of the data of at least two of the infrared rays projected from the plurality of light projection portions overlap each other for a predetermined time.

5. The infrared detection sensor according to claim 1,
wherein the phototransmitter is provided with an identification means for identifying the light reception portion which received the infrared rays, among the plurality of light reception portions.

6. The infrared detection sensor according to claim 1,
wherein the detection zone formed by the infrared rays projected from the plurality of light projection portions is made of a plurality of layers.

7. The infrared detection sensor according to claim 2,
wherein the phototransmitter is provided with an identification means for identifying the light reception portion which received the infrared rays, among the plurality of light reception portions.

8. The infrared detection sensor according to claim 3,
wherein the phototransmitter is provided with an identification means for identifying the light reception portion which received the infrared rays, among the plurality of light reception portions.

9. The infrared detection sensor according to claim 4,
wherein the phototransmitter is provided with an identification means for identifying the light reception portion which received the infrared rays, among the plurality of light reception portions.

10. The infrared detection sensor according to claim 2,
wherein the detection zone formed by the infrared rays projected from the plurality of light projection portions is made of a plurality of layers.

11. The infrared detection sensor according to claim 3,
wherein the detection zone formed by the infrared rays projected from the plurality of light projection portions is made of a plurality of layers.

12. The infrared detection sensor according to claim 4,
wherein the detection zone formed by the infrared rays projected from the plurality of light projection portions is made of a plurality of layers.

13. The infrared detection sensor according to claim 5,
wherein the detection zone formed by the infrared rays projected from the plurality of light projection portions is made of a plurality of layers.

14. The infrared detection sensor according to claim 7,
wherein the detection zone formed by the infrared rays projected from the plurality of light projection portions is made of a plurality of layers.

15. The infrared detection sensor according to claim 8,
wherein the detection zone formed by the infrared rays projected from the plurality of light projection portions is made of a plurality of layers.

16. The infrared detection sensor according to claim 9,
wherein the detection zone formed by the infrared rays projected from the plurality of light projection portions is made of a plurality of layers.
